(19) United States
(12) Patent Application Publication
(10) Pub. No.: US 2017/0201742 A1
(43) Pub. Date: Jul. 13, 2017

(54) Display Device and Operating Method Thereof

(71) Applicant: BOE TECHNOLOGY GROUP CO., LTD., Beijing (CN)

(72) Inventors: Song SONG, Beijing (CN); Kazuyoshi NAGAYAMA, Beijing (CN)

(73) Assignee: BOE TECHNOLOGY GROUP CO., LTD., Beijing (CN)

(21) Appl. No.: 15/104,644

(22) PCT Filed: Jan. 7, 2016
(86) PCT No.: PCT/CN2016/070354

§ 371 Date: Jun. 15, 2016

(30) Foreign Application Priority Data
Jul. 28, 2015 (CN) 201510451026.2

(51) Int. Cl. H04N 13/04

(52) U.S. Cl. CPC H04N 13/0425; H04N 13/0402; H04N 13/0452

(57) ABSTRACT

The present invention provides a display device and an operating method thereof, the display device comprises a first display panel, a second display panel and a backlight, the first display panel is flexibly connected with the second display panel, the first display panel is provided at a light-exiting surface side of the backlight; a light-exiting surface of the first display panel can be arranged to be closely adjacent to and faces the first surface of the second display panel, and the second pixel panel forms light-shielding regions and light-transmitting regions; and first display panel forms a left image for a left eye of a viewer and a right image for a right eye of the viewer, so that the viewer can only see the left image by his left eye and only see the right image by his right eye by means of the light-shielding regions and the light-transmitting regions.

### FIELD OF THE INVENTION

The present invention relates to the field of display technology, and particularly to a display device and an operating method thereof.

### BACKGROUND OF THE INVENTION

Main principle of 3D display technology is that a left eye and a right eye of a viewer receive different images respectively, and the viewer can perceive the levels of the images by analyzing and overlapping the image for left eye and the image for right eye in the viewer's brain so as to produce a stereoscopic sense.

At present, the 3D display devices are mainly classified into two types, one type of the 3D display devices is one required to be viewed by wearing 3D glasses, and the other type of the 3D display devices is autostereoscopic 3D display. Parallax barrier technology is a kind of autostereoscopic 3D technology, which, by means of a parallax barrier member, enables the image for left eye to be seen only by the left eye and cannot be seen by the right eye, at the same time, the image for right eye to be seen only by the right eye and cannot be seen by the left eye, so that a picture for left eye and a picture for right eye are formed respectively, and a 3D picture is formed finally. Therefore, it is required to add an extra parallax barrier member for an existing 3D display to realize 3D display. However, there is limitation to the existing display device realizing 3D display by means of the parallax barrier member, for example, since the parallax barrier member is fixed on the display panel, the display device can only display 3D image, and since sizes and positions of the light-shielding regions of the parallax barrier member are fixed, it is impossible for the parallax barrier member to be adapted to distances between two eyes of various viewers and to self-adaptively adjusts distance from a viewer to the display to obtain optimum 3D display effect.

### SUMMARY OF THE INVENTION

In view of the above problem, the present invention provides a display device and an operating method thereof, which can solve the limitation to the 3D display and defect in which the 3D display cannot be effectively adjusted.

The present invention provides a display device comprising a first display panel, a second display panel and a backlight, the first display panel is flexibly connected with the second display panel, the first display panel is provided at a light-exiting surface side of the backlight, the second display panel comprises a first surface and a second surface which are provided opposite to each other, the first display panel comprises a first pixel array, the second display panel comprises a second pixel array, the first pixel array comprises a plurality of first pixel units arranged regularly, the first pixel unit comprises a plurality of sub-pixels, the second pixel array comprises a plurality of second pixel units arranged regularly, the second pixel unit comprises a plurality of sub-pixels, wherein a light-exiting surface of the first display panel and the first surface of the second display panel are provided at a same side of the display device, the second display panel is transparent, and wherein

the second display panel is capable of being folded to the first display panel along a first direction, so that the light-exiting surface of the first display panel is closely adjacent to and faces the first surface of the second display panel, and the second pixel array forms light-shielding regions and light-transmitting regions; and the first pixel array forms a left image for a left eye of a viewer and a right image for a right eye of the viewer, so that the viewer can only see the left image by his left eye and only see the right image by his right eye through the light-shielding regions and the light-transmitting regions.

Preferably, the backlight is a double-sided illumination backlight.

Preferably, the second display panel is also capable of being folded to the first display panel along a second direction, so that the light-incoming surface of the first display panel is closely adjacent to and faces the second surface of the second display panel, the backlight supplies light to the first display panel and the second display panel, so that the first display panel displays a first display picture and the second display panel displays a second display picture, wherein the first direction is contrary to the second direction.

Preferably, the first display panel and the second display panel are also capable of being arranged side by side, so that the first display panel transmits light of the backlight, and the second display panel transmits ambient light from a light-incoming surface side of the second display panel.

Preferably, light-exiting surface of the first display panel and the first surface of the second display panel are provided with a flexible transparent flat film, which is configured to form contact surfaces between the first display panel and the second display panel when the second display panel is folded to the first display panel along the first direction, so that light emitted from the first display panel radiates on the second display panel uniformly.

Preferably, the display device further comprises a sensor and a processor, the sensor and the processor are provided in a peripheral region of the second display panel, wherein

the sensor is configured to measure a distance between the left eye and the right eye of the viewer, and

the processor is configured to adjust widths of the light-shielding regions based on the distance between the eyes and a preset width of a sub-pixel of the first pixel unit.

Preferably, the processor is configured to adjust the widths of the light-shielding regions according to the following light-shielding region adjusting formula:

$$c = \frac{4 pl}{p + l}$$

where c is the width of the light-shielding region, p is the width of the sub-pixel of the first pixel unit, and l is the distance between eyes of the viewer.

Preferably, the sensor comprises a camera, when the light-exiting surface of the first display panel is provided to be closely adjacent to and face the first surface of the second display panel, the camera is rotated to be at the second surface,

when the light-incoming surface of the first display panel is provided to be closely adjacent to and face the second surface of the second display panel, the camera is rotated to be at the first surface.

The present invention further provides an operating method of a display device, wherein the display device comprises a first display panel, a second display panel and a backlight, the first display panel is flexibly connected with the second display panel, the first display panel is provided at a light-exiting surface side of the backlight, the second display panel comprises a first surface and a second surface which are provided opposite to each other, the first display panel comprises a first pixel array, the second display panel comprises a second pixel array, the first pixel array comprises a plurality of first pixel units arranged regularly, the first pixel unit comprises a plurality of sub-pixels, the second pixel array comprises a plurality of second pixel units arranged regularly, the second pixel unit comprises a plurality of sub-pixels, wherein a light-exiting surface of the first display panel and the first surface of the second display panel are provided at a same side of the display device, the second display panel is transparent, and wherein

the operating method comprises:

folding the first display panel and the second display panel along a first direction, so that the light-exiting surface of the first display panel is closely adjacent to and faces the first surface of the second display panel, and the second pixel array forms light-shielding regions and light-transmitting regions; and

causing the first pixel array to form a left image for a left eye of a viewer and a right image for a right eye of the viewer, so that the viewer can only see the left image by his left eye and only see the right image by his right eye through the light-shielding regions and the light-transmitting regions.

Preferably, the backlight is a double-sided illumination backlight, and the operating method further comprises:

folding the first display panel and the second display panel along a second direction, so that a light-incoming surface of the first display panel is closely adjacent to and faces the second surface of the second display panel;

causing the backlight to supply light to the first display panel and the second display panel; and

causing the first display panel to display a first display picture and the second display panel display a second display picture,

wherein the first direction is contrary to the second direction.

Preferably, the display device further comprises a sensor and a processor, the sensor and the processor are provided in a peripheral region of the second display panel, wherein the operating method further comprises:

measuring, by the sensor, a distance between the left eye and the right eye of the viewer; and

adjusting, by the processor, widths of the light-shielding regions based on the distance between the eyes and a preset width of a sub-pixel of the first pixel unit.

Preferably, the step of adjusting, by the processor, widths of the light-shielding regions based on the distance between the eyes and a preset width of a sub-pixel of the first pixel unit comprises a step of:

adjusting, by the processor, the widths of the light-shielding regions according to the following light-shielding region adjusting formula:

$$c = \frac{4 pl}{p + l}$$

where c is the width of the light-shielding region, p is the width of the sub-pixel of the first pixel unit, and l is the distance between the eyes of the viewer.

Preferably, the sensor comprises a camera, and the operating method further comprises:

when the light-exiting surface of the first display panel is provided to be closely adjacent to and face the first surface of the second display panel, the camera is rotated to be at the second surface, and

when the light-incoming surface of the first display panel is provided to be closely adjacent to and face the second surface of the second display panel, the camera is rotated to be at the first surface.

The present invention has the following advantages:

In the display device and the operating method thereof, the display device comprises a first display panel, a second display panel and a backlight, the first display panel is flexibly connected with the second display panel, the first display panel is provided at a light-exiting surface side of the backlight; the second display panel is capable of being folded to the first display panel along a first direction, so that the light-exiting surface of the first display panel is closely adjacent to and faces the first surface of the second display panel, and the second pixel array forms light-shielding regions and light-transmitting regions; and first pixel array forms a left image for a left eye of a viewer and a right image for a right eye of the viewer, so that the viewer can only see the left image by his left eye and only see the right image by his right eye through the light-shielding regions and a light-transmitting regions. The display device in the present invention overcomes the limitation of the 3D display device in the prior art, so that the display device can perform not only 3D display and 2D display, but also double-sided display. In addition, it is possible to adaptively adjust widths of the light-shielding regions to realize optimum 3D display effect according to distances between two eyes of various viewers and distance from a viewer to the display.

### BRIEF DESCRIPTION OF THE DRAWINGS

FIG. 1 is a front view of a display device provided in a first embodiment of the present invention;

FIG. 2 is a rear view of the display device of FIG. 1;

FIG. 3 is a structural diagram of a first pixel array and a second pixel array in the first embodiment;

FIG. 4 is a front view of the display device shown in FIG. 1 which is folded along a first direction;

FIG. 5 is a rear view of the display device shown in FIG. 1 which is folded along the first direction;

FIG. 6 is a top view of the display device shown in FIG. 4 which is folded along the first direction;

FIG. 7 is a structural diagram of light-shielding regions and light-transmitting regions formed in the display device shown in FIG. 6;

FIG. 8 is a diagram illustrating the principle of 3D display preformed by the display device shown in FIG. 7;

FIG. 9 is a top view of another display device provided in the first embodiment of the present invention;

FIG. 10 is a front view of the display device shown in FIG. 1 which is folded along a second direction;

FIG. 11 is a rear view of the display device shown in FIG. 1 which is folded along the second direction;

FIG. 12 is a top view of the display device shown in FIG. 10 which is folded along the second direction; and

FIG. 13 is a light path diagram of the display device shown in FIG. 12 which is in a double-sided display state.

### DETAILED DESCRIPTION OF THE EMBODIMENTS

In order to make persons skilled in the art better understand the solutions of the present invention, the display device and the operating method thereof will be described below in detail in conjunction with the accompanying drawings.

### First Embodiment

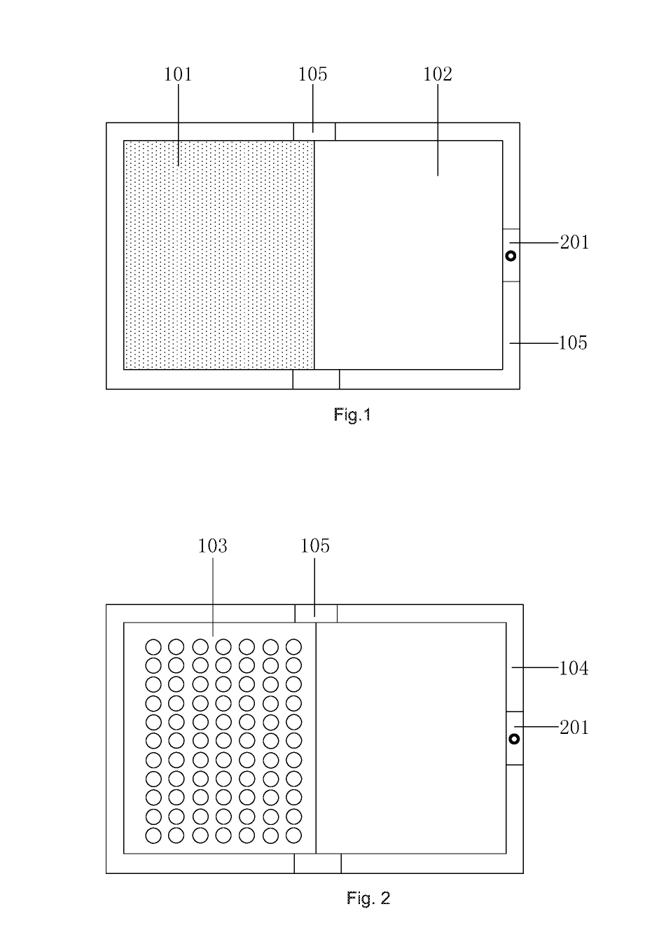

FIG. 1 is a front view of a display device provided in a first embodiment of the present invention, and FIG. 2 is a rear view of the display device of FIG. 1. As shown in FIG. 1 and FIG. 2, the display device comprises a first display panel 101, a second display panel 102 and a backlight 103, the first display panel 101 is flexibly connected with the second display panel 102, the first display panel 101 is provided at a light-exiting surface side of the backlight 103, the second display panel 102 comprises a first surface and a second surface which are provided opposite to each other, the second display panel 102 is a transparent display panel. As shown in FIG. 1, the first surface of the second display panel 102 is located at the front side of the display device, and the second surface of the second display panel 102 is located at the rear side of the display device.

With reference to FIG. 1 and FIG. 2, the first display panel 101 and the second display panel 102 are arranged side by side, the first display panel 101 may transmit light of the backlight, and the second display panel 102 may transmit ambient light from a light-incoming surface side of the second display panel. Specifically, the second display panel 102 transmits ambient light from the rear side thereof, so that a viewer in front of the second display panel 102 can see the background behind the second display panel 102, and thus a transparent display function is realized.

Optionally, a flexible circuit board is provided at a boundary region of the second display panel 102. Sides of the first display panel 101 and the second display panel 102 are provided with rigid frames 104, sides of a connecting portion between the first display panel 101 and the second display panel 102 are provided with flexible frames 105. Optionally, the backlight 103 includes a plurality of uniformly distributed light-emitting diodes. Preferably, the light-emitting diodes are white light-emitting diodes, brightness of which are adjustable.

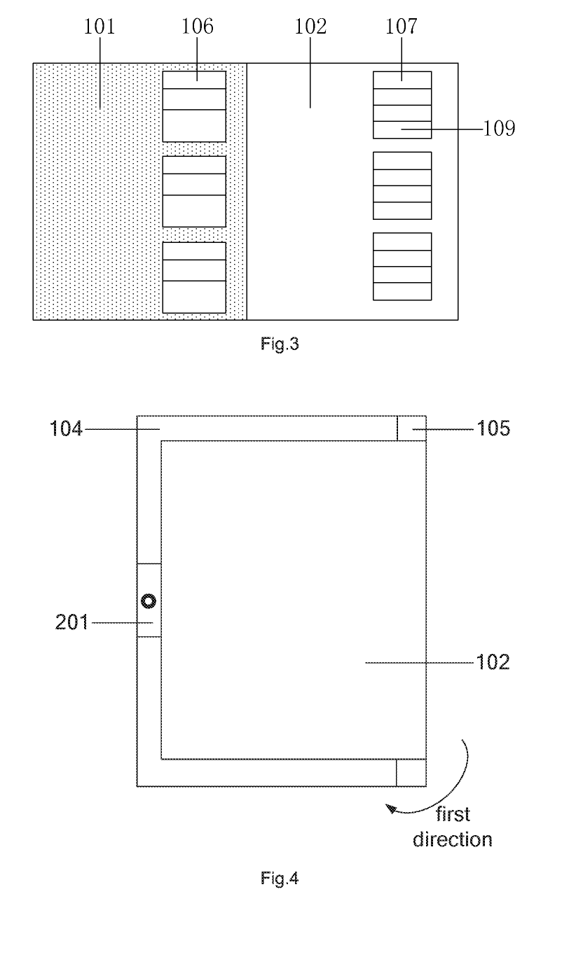

FIG. 3 is a structural diagram of a first pixel array and a second pixel array in the first display panel and the display panel shown in FIG. 1. As shown in FIG. 3, the first display panel 101 comprises a first pixel array 106, the second display panel 102 comprises a second pixel array 107, the first pixel array comprises a plurality of first pixel units arranged regularly, the first pixel unit comprises a plurality of sub-pixels, the second pixel array comprises a plurality of second pixel units arranged regularly, the second pixel unit comprises a plurality of sub-pixels.

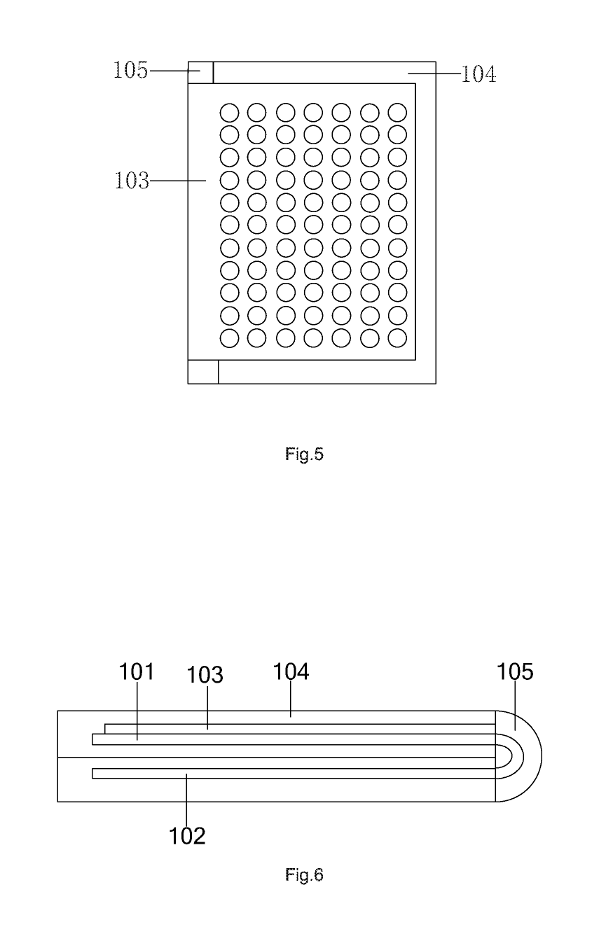

FIG. 4 is a front view of the display device shown in FIG. 1 which is folded along a first direction, FIG. 5 is a rear view of the display device shown in FIG. 1 which is folded along the first direction, and FIG. 6 is a top view of the display device shown in FIG. 1 which is folded along the first direction. The first direction is a direction in which the second display panel 102 is rotated clockwise to overlap with the first display panel 101 with a boundary between the first display panel 101 and the second display panel 102 as an axis. As shown in FIG. 4 to FIG. 6, when the first display panel 101 and the second display panel 102 are folded along the first direction, a light-exiting surface of the first display panel 101 is closely adjacent to and faces the first surface of the second display panel 102.

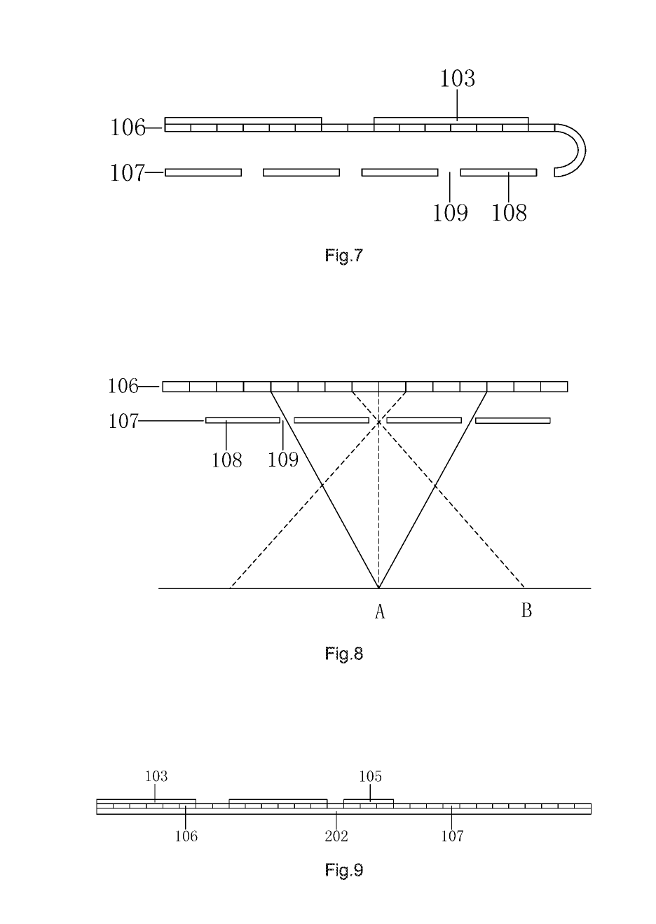

FIG. 7 is a structural diagram of light-shielding regions and light-transmitting regions formed in the display device shown in FIG. 6, and FIG. 8 is a diagram illustrating the principle of 3D display preformed by the display device shown in FIG. 7. As shown in FIG. 7 and FIG. 8, gray values of part of sub-pixels of the second pixel array 107 are set to zero, the part of sub-pixels display black to form light-shielding regions 108, at the same time, gray values of the other part of the sub-pixels of the second pixel array 107 are set to a maximum value so as to form light-transmitting regions 109. The formed light-shielding regions 108 and the light-transmitting regions 109 are shown in FIG. 7 and FIG. 8. By the light-shielding regions 108 and the light-transmitting regions 109, the left eye of the viewer can only see a left image for left eye formed on the first pixel array 106, and the right eye of the viewer can only see a right image for right eye formed on the first pixel array 106, thus autostereoscopic 3D display is realized.

In the present embodiment, the display device further comprises a sensor and a processor (not shown in figures), the sensor and the processor are provided in a peripheral region of the second display panel. The sensor measures a distance between the left eye and the right eye of the viewer, and the processor adjusts widths of the light-shielding regions, that is, the number of sub-pixels displaying black, based on the distance between eyes and a preset width of a sub-pixel of the first pixel unit. Preferably, the processor adjusts the widths of the light-shielding regions according to the following light-shielding region adjusting formula:

$$c = \frac{4 pl}{p + l}$$

where c is the width of the light-shielding region 108, p is the width of the sub-pixel of the first pixel unit in the first pixel array 106, and l is the distance between eyes of the viewer.

With reference to FIG. 8, point A is a position of the left eye, and point B is a position of the right eye, according to the similar triangle theorem, the following equations can be obtained:

$$\begin{matrix}\frac{h}{s} = \frac{p}{l} & ( 1 ) \\ \frac{c}{4 p} = \frac{s}{s + h} & ( 2 )\end{matrix}$$

where h is a distance between the first pixel array 106 and the second pixel array 107, s is a distance between the eyes and the second pixel array 107, p is a width of the sub-pixel in the first pixel array 106, l is the distance between the eyes, and c is a width of the light-shielding region 108. The light-shielding region adjusting formula may be obtained based on the equation (1) and the equation (2). The widths of the light-shielding regions may be adjusted by the above light-shielding region adjusting formula, so that 3D display performance of the display device can be improved. In addition, to facilitate the implementation, sub-pixels of the first pixel array 106 and sub-pixels of the second pixel array 107 in the present embodiment are the same in size.

FIG. 9 is a top view of another display device provided the first embodiment of the present invention. As shown in FIG. 9, light-exiting surface of the first display panel and the first surface of the second display panel are provided with a flexible transparent flat film 202, which is configured to form contact surfaces between the first display panel and the second display panel when the second display panel is folded to the first display panel as shown in FIG. 6, so that light emitted from the first display panel radiates on the second display panel uniformly, thus the quality of the displayed picture of the display device is improved.

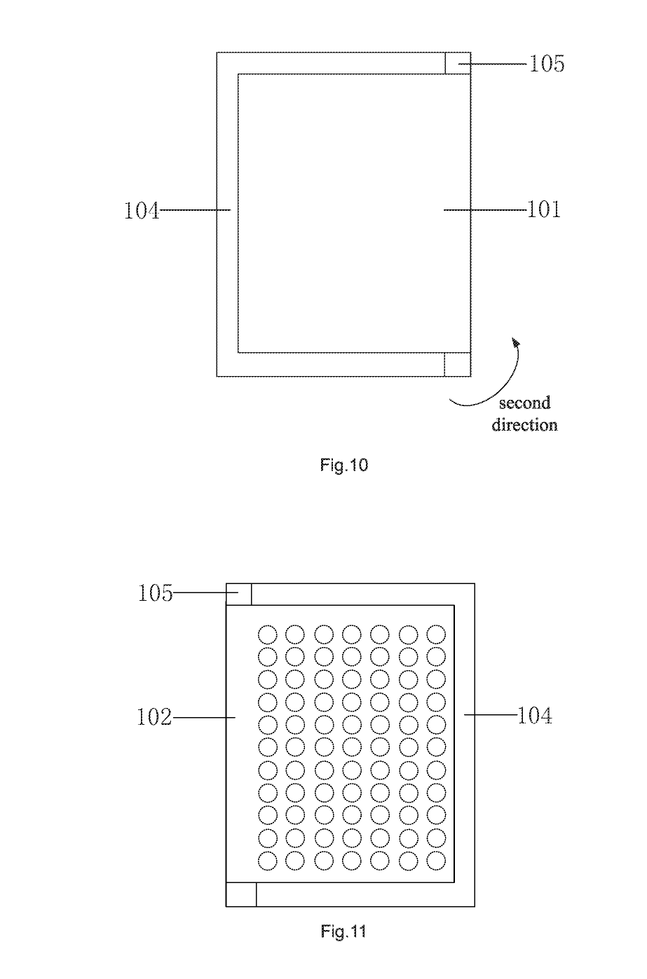

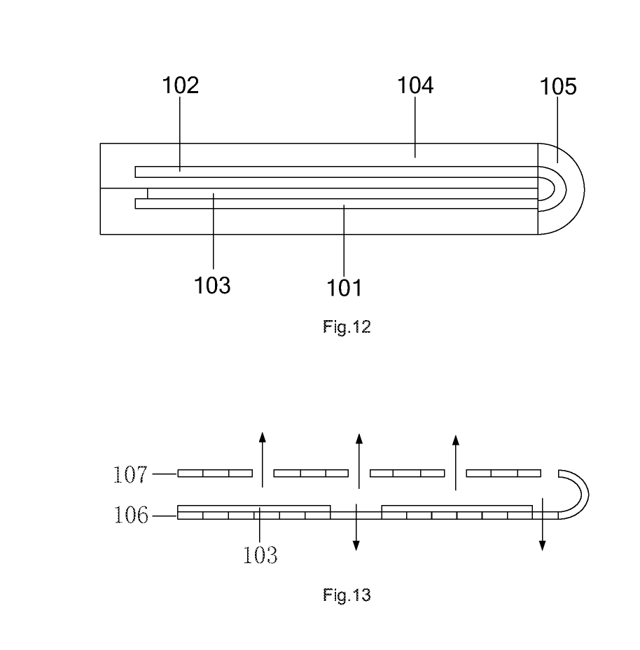

FIG. 10 is a front view of the display device shown in FIG. 1 which is folded along a second direction, FIG. 11 is a rear view of the display device shown in FIG. 1 which is folded along the second direction, and FIG. 12 is a top view of the display device shown in FIG. 10 which is folded along the second direction. As shown in FIG. 10 to FIG. 12, when the first display panel 101 and the second display panel 102 are folded in the second direction, light-incoming surface of the first display panel 101 faces the second surface of the second display panel 102. The first display panel 101 is configured to form a first display picture, the second display panel 102 is configured to form a second display picture, the first direction is contrary to the second direction, that is, the second direction is a direction in which the second display panel 102 is rotated anticlockwise to overlap with the first display panel 101 with a boundary between the first display panel 101 and the second display panel 102 as an axis.

FIG. 13 is a light path diagram of the display device shown in FIG. 12 which is in a double-sided display state. As shown in FIG. 13, the backlight 103 is a double-sided illumination backlight and is used to supply light to the first display panel 101 and the second display panel 102 after the first display panel 101 and the second display panel 102 are folded. Specifically, the backlight 103 can supply light for the first display panel 101, and can also supply light for the second display panel 102, so that the first display panel 101 may form the first display picture and the second display panel 102 may form the second display picture, thus a double-sided display function is realized. Optionally, the backlight 103 may be used as a lamp, or as a flash lamp when a camera operates.

With reference to FIG. 1 and FIG. 2, the sensor comprises a camera 201, when the light-exiting surface of the first display panel 101 is provided to face the first surface of the second display panel 102, the camera 201 is rotated to be at the second surface. When the light-incoming surface of the first display panel 101 is provided to face the second surface of the second display panel 102, the camera 201 is rotated to be at the first surface.

The display device provided in the present embodiment comprises a first display panel, a second display panel and a backlight, the first display panel is flexibly connected with the second display panel, the first display panel is provided at a light-exiting surface side of the backlight; when the light-exiting surface of the first display panel is arranged to be closely adjacent to and face the first surface of the second display panel, the second display panel forms light-shielding regions and light-transmitting regions. The first display panel forms a left image for a left eye of a viewer and a right image for a right eye of the viewer through the light-shielding regions and light-transmitting regions. The solution provided by the present embodiment can realize 3D display without adding an extra parallax barrier member.

### Second Embodiment

The present embodiment provides an operating method of the display device, wherein the display device comprises a first display panel, a second display panel and a backlight. As shown in FIG. 1 and FIG. 2, the first display panel 101 is flexibly connected with the second display panel 102, the first display panel 101 is provided at a light-exiting surface side of the backlight 103, and the second display panel 102 comprises a first surface and a second surface. With reference to FIG. 3, the first display panel 101 comprises a first pixel array 106, the second display panel 102 comprises a second pixel array 107, the first pixel array comprises a plurality of first pixel units arranged regularly, the first pixel unit comprises a plurality of sub-pixels, the second pixel array comprises a plurality of second pixel units arranged regularly, the second pixel unit comprises a plurality of sub-pixels.

The operating method comprises: when the first display panel and the second display panel are folded along the first direction, a light-exiting surface of the first display panel is closely adjacent to and faces the first surface of the second display panel, and the second pixel array forms light-shielding regions and light-transmitting regions. The first pixel array forms a left image for a left eye of a viewer and a right image for a right eye of the viewer by means of the light-shielding regions and the light-transmitting regions. The first direction is a direction in which the second display panel 102 is rotated clockwise to overlap with the first display panel 101 with a boundary between the first display panel 101 and the second display panel 102 as an axis.

With reference to FIG. 4 to FIG. 8, when the second display panel 102 is folded to the first display panel 101 along the first direction, the light-exiting surface of the first display panel 101 is closely adjacent to and faces the first surface of the second display panel 102. When gray values of sub-pixels of the second pixel array 107 are set to zero, the second pixel array forms the light-shielding regions and the light-transmitting regions, by means of which, the first pixel array 106 forms a left image for the left eye and a right image for the right eye, and thus 3D display can be realized without adding an extra parallax barrier member.

In the present embodiment, the operating method further comprises: when the first display panel and the second display panel are folded along the second direction, the light-incoming surface of the first display panel is closely adjacent to and faces the second surface of the second display panel, the first display panel forms a first display picture, and the second display panel forms a second display picture, the first direction is contrary to the second direction, that is, the second direction is a direction in which the second display panel 102 is rotated anticlockwise to overlap with the first display panel 101 with a boundary between the first display panel 101 and the second display panel 102 as an axis. With reference to FIG. 10 to FIG. 13, the backlight can not only supply light to the first display panel 101, but also supply light to the second display panel 102, so that the first display panel 101 forms the first display picture, and the second display panel 102 forms the second display picture, thus a double-sided display performance is realized.

In the present embodiment, the display device further comprises a sensor and a processor, the sensor and the processor are provided in a peripheral region of the second display panel. The operating method further comprises: the sensor measures a distance between the left eye and the right eye of the viewer; and the processor adjusts widths of the light-shielding regions based on the distance between eyes and a preset width of a sub-pixel of the first pixel array 106. Preferably, the step of the processor adjusts widths of the light-shielding regions based on the distance between eyes and a preset width of a sub-pixel of the first pixel unit comprises a step of: the processor adjusts the widths of the light-shielding regions according to the following light-shielding region adjusting formula:

$$c = \frac{4 pl}{p + l}$$

where c is the width of the light-shielding region 108, p is the width of the sub-pixel of the first pixel unit in the first pixel array 106, and l is the distance between eyes of the viewer.

With reference to FIG. 8, according to the similar triangle theorem, the following equations can be obtained:

$$\begin{matrix}\frac{h}{s} = \frac{p}{l} & ( 1 ) \\ \frac{c}{4 p} = \frac{s}{s + h} & ( 2 )\end{matrix}$$

where h is a distance between the first pixel array 106 and the second pixel array 107, s is a distance between the eyes and the second pixel array 107, p is a width of the sub-pixel in the first pixel array 106, l is the distance between the eyes, and c is a width of the light-shielding region 108. The light-shielding region adjusting formula may be obtained based on the equation (1) and the equation (2). The width of the light-shielding region may be adjusted by the above light-shielding region adjusting formula, so that 3D display performance of the display device can be improved.

Preferably, the sensor comprises a camera, and the operating method further comprises: when the light-exiting surface of the first display panel is provided to be closely adjacent to and face the first surface of the second display panel, the camera is rotated to be at the second surface; and when the light-incoming surface of the first display panel is provided to be closely adjacent to and face the second surface of the second display panel, the camera is rotated to be at the first surface.

The operating method of the display device provided in the present embodiment comprises: when the first display panel and the second display panel are folded along the first direction, the light-exiting surface of the first display panel is closely adjacent to and faces the first surface of the second display panel, the second pixel array forms light-shielding regions and light-transmitting regions. The first display panel forms a left image for a left eye of a viewer and a right image for a right eye of the viewer by means of the light-shielding regions and light-transmitting regions. The solution provided by the present embodiment can realize 3D display without adding an extra parallax barrier member.

It can be understood that the foregoing implementations are merely exemplary embodiments for the purpose of explaining the principle of the present disclosure, but the present disclosure is not limited thereto. Various modifications and improvements can be made by those of ordinary skills in the art without departing from the spirit and essence of the present disclosure. These modifications and improvements shall also fall into the protection scope of the present disclosure.

1-13. (canceled)

14. A display device comprising a first display panel, a second display panel and a backlight, the first display panel is flexibly connected with the second display panel, the first display panel is provided at a light-exiting surface side of the backlight, the second display panel comprises a first surface and a second surface which are provided opposite to each other, the first display panel comprises a first pixel array, the second display panel comprises a second pixel array, the first pixel array comprises a plurality of first pixel units arranged regularly, the first pixel unit comprises a plurality of sub-pixels, the second pixel array comprises a plurality of second pixel units arranged regularly, the first pixel unit comprises a plurality of sub-pixels, wherein a light-exiting surface of the first display panel and the first surface of the second display panel are provided at a same side of the display device, the second display panel is transparent, and wherein
the second display panel is capable of being folded to the first display panel along a first direction, so that the light-exiting surface of the first display panel is closely adjacent to and faces the first surface of the second display panel, and the second pixel array forms light-shielding regions and light-transmitting regions; and the first pixel array forms a left image for a left eye of a viewer and a right image for a right eye of the viewer, so that the viewer can only see the left image by his left eye and only see the right image by his right eye through the light-shielding regions and the light-transmitting regions.

15. The display device of claim 14, wherein the backlight is a double-sided illumination backlight.

16. The display device of claim 15, wherein the second display panel is also capable of being folded to the first display panel along a second direction, so that a light-incoming surface of the first display panel is closely adjacent to and faces the second surface of the second display panel, the backlight supplies light to the first display panel and the second display panel, so that the first display panel displays a first display picture and the second display panel displays a second display picture, wherein the first direction is contrary to the second direction.

17. The display device of claim 14, wherein the first display panel and the second display panel are also capable of being arranged side by side, so that the first display panel transmits light of the backlight, and the second display panel transmits ambient light from a light-incoming surface side of the second display panel.

18. The display device of claim 14, wherein light-exiting surface of the first display panel and the first surface of the second display panel are provided with a flexible transparent flat film, which is configured to form contact surfaces between the first display panel and the second display panel when the second display panel is folded to the first display panel along the first direction, so that light emitted from the first display panel radiates on the second display panel uniformly.

19. The display device of claim 14, further comprising a sensor and a processor, the sensor and the processor are provided in a peripheral region of the second display panel, wherein the sensor is configured to measure a distance between the left eye and the right eye of the viewer, and
the processor is configured to adjust widths of the light-shielding regions based on the distance between the eyes and a preset width of a sub-pixel of the first pixel unit.

20. The display device of claim 15, further comprising a sensor and a processor, the sensor and the processor are provided in a peripheral region of the second display panel, wherein the sensor is configured to measure a distance between the left eye and the right eye of the viewer, and
the processor is configured to adjust widths of the light-shielding regions based on the distance between the eyes and a preset width of a sub-pixel of the first pixel unit.

21. The display device of claim 16, further comprising a sensor and a processor, the sensor and the processor are provided in a peripheral region of the second display panel, wherein the sensor is configured to measure a distance between the left eye and the right eye of the viewer, and
the processor is configured to adjust widths of the light-shielding regions based on the distance between the eyes and a preset width of a sub-pixel of the first pixel unit.

22. The display device of claim 17, further comprising a sensor and a processor, the sensor and the processor are provided in a peripheral region of the second display panel, wherein the sensor is configured to measure a distance between the left eye and the right eye of the viewer, and
the processor is configured to adjust widths of the light-shielding regions based on the distance between the eyes and a preset width of a sub-pixel of the first pixel unit.

23. The display device of claim 18, further comprising a sensor and a processor, the sensor and the processor are provided in a peripheral region of the second display panel, wherein the sensor is configured to measure a distance between the left eye and the right eye of the viewer, and
the processor is configured to adjust widths of the light-shielding regions based on the distance between the eyes and a preset width of a sub-pixel of the first pixel unit.

24. The display device of claim 19, wherein the processor is configured to adjust the widths of the light-shielding regions according to the following light-shielding region adjusting formula:
$$c = \frac{4 pl}{p + l}$$
where c is the width of the light-shielding region, p is the width of the sub-pixel of the first pixel unit, and l is the distance between eyes of the viewer.

25. The display device of claim 19, wherein the sensor comprises a camera, when the light-exiting surface of the first display panel is provided to be closely adjacent to and face the first surface of the second display panel, the camera is rotated to be at the second surface, when the light-incoming surface of the first display panel is provided to be closely adjacent to and face the second surface of the second display panel, the camera is rotated to be at the first surface.

26. An operating method of a display device, wherein the display device comprises a first display panel, a second display panel and a backlight, the first display panel is flexibly connected with the second display panel, the first display panel is provided at a light-exiting surface side of the backlight, the second display panel comprises a first surface and a second surface which are provided opposite to each other, the first display panel comprises a first pixel array, the second display panel comprises a second pixel array, the first pixel array comprises a plurality of first pixel units arranged regularly, the first pixel unit comprises a plurality of sub-pixels, the second pixel array comprises a plurality of second pixel units arranged regularly, the second pixel unit comprises a plurality of sub-pixels, wherein a light-exiting surface of the first display panel and the first surface of the second display panel are provided at a same side of the display device, the second display panel is transparent, and wherein
the operating method comprises:
folding the first display panel and the second display panel along a first direction, so that the light-exiting surface of the first display panel is closely adjacent to and faces the first surface of the second display panel, and the second pixel array forms light-shielding regions and light-transmitting regions; and
causing the first pixel array to form a left image for a left eye of a viewer and a right image for a right eye of the viewer, so that the viewer can only see the left image by his left eye and only see the right image by his right eye through the light-shielding regions and the light-transmitting regions.

27. The operating method of the display device of claim 26, wherein the backlight is a double-sided illumination backlight, and the operating method further comprises:
folding the first display panel and the second display panel along a second direction, so that a light-incoming surface of the first display panel is closely adjacent to and faces the second surface of the second display panel;
causing the backlight to supply light to the first display panel and the second display panel; and
causing the first display panel to display a first display picture and the second display panel to display a second display picture,
wherein the first direction is contrary to the second direction.

28. The operating method of the display device of claim 26, wherein the display device further comprises a sensor and a processor, the sensor and the processor are provided in a peripheral region of the second display panel, wherein the operating method further comprises:
measuring, by the sensor, a distance between the left eye and the right eye of the viewer; and
adjusting, by the processor, widths of the light-shielding regions based on the distance between the eyes and a preset width of a sub-pixel of the first pixel unit.

29. The operating method of the display device of claim 27, wherein the display device further comprises a sensor and a processor, the sensor and the processor are provided in a peripheral region of the second display panel, wherein the operating method further comprises:
measuring, by the sensor, a distance between the left eye and the right eye of the viewer; and
adjusting, by the processor, widths of the light-shielding regions based on the distance between the eyes and a preset width of a sub-pixel of the first pixel unit.

30. The operating method of the display device of claim 28, wherein the step of adjusting, by the processor, widths of the light-shielding regions based on the distance between the eyes and a preset width of a sub-pixel of the first pixel unit comprises a step of:
adjusting, by the processor, the widths of the light-shielding regions according to the following light-shielding region adjusting formula:
$$c = \frac{4 pl}{p + l}$$
where c is the width of the light-shielding region, p is the width of the sub-pixel of the first pixel unit, and l is the distance between the eyes of the viewer.

31. The operating method of the display device of claim 29, wherein the step of adjusting, by the processor, widths of the light-shielding regions based on the distance between the eyes and a preset width of a sub-pixel of the first pixel unit comprises a step of:
adjusting, by the processor, the widths of the light-shielding regions according to the following light-shielding region adjusting formula:
$$c = \frac{4 pl}{p + l}$$
where c is the width of the light-shielding region, p is the width of the sub-pixel of the first pixel unit, and l is the distance between the eyes of the viewer.

32. The operating method of the display device of claim 28, wherein the sensor comprises a camera, and the operating method further comprises:
when the light-exiting surface of the first display panel is provided to be closely adjacent to and face the first surface of the second display panel, the camera is rotated to be at the second surface, and
when the light-incoming surface of the first display panel is provided to be closely adjacent to and face the second surface of the second display panel, the camera is rotated to be at the first surface.

33. The operating method of the display device of claim 29, wherein the sensor comprises a camera, and the operating method further comprises:
when the light-exiting surface of the first display panel is provided to be closely adjacent to and face the first surface of the second display panel, the camera is rotated to be at the second surface, and
when the light-incoming surface of the first display panel is provided to be closely adjacent to and face the second surface of the second display panel, the camera is rotated to be at the first surface.
